(19) United States
(12) Patent Application Publication
(10) Pub. No.: US 2026/0104293 A1
(43) Pub. Date: Apr. 16, 2026

(54) E-MOTOR AXIAL STATOR WINDING TEMPERATURE SENSOR

(71) Applicant: SENSATA TECHNOLOGIES, INC., ATTLEBORO, MA (US)

(72) Inventors: HRISTO ZLATINOV MAYSTOROV, SOFIA (BG); NIKOLAY SHTOKMANOV TANEV, SOFIA (BG); PETKO NIKOLAEV HRISTOV, BOTEVGRAD (BG); PANAYOT HRISTOV PARUSHEV, SOFIA (BG); VALENTIN GRIGOROV GRIGOROV, SOFIA (BG); ERVIN HYUSEIN ALI, SOFIA (BG)

(21) Appl. No.: 19/113,770

(22) PCT Filed: Sep. 22, 2023
(86) PCT No.: PCT/US2023/033516

§ 371 Date: Mar. 20, 2025

Related U.S. Application Data
(60) Provisional application No. 63/409,186, filed on Sep. 22, 2022.

(51) Int. Cl. G01K 1/14; G01K 7/22; H02K 11/25; H02K 15/40

(52) U.S. Cl. CPC G01K 1/146; G01K 7/22; H02K 11/25; H02K 15/40; G01K 2205/00

(57) ABSTRACT

Apparatuses, temperature sensors, and methods for assembling an e-motor axial stator winding temperature sensor are disclosed. In a particular embodiment, the temperature sensor includes a housing configured to be fixed relative to an electric motor. The temperature sensor also includes a plunger disposed in the housing and a thermal sensor disposed in the plunger. In this embodiment, the plunger is movable relative to the housing to position the thermal sensor relative to the electric motor.

### FIELD OF THE TECHNOLOGY

The subject disclosure relates to a temperature sensor for use with electric motors.

### BACKGROUND

Different systems, like automobiles, are increasingly using electric motors (e-motors). However, e-motors may overheat during use, leading to motor and/or system failures. Some conventional e-motor designs incorporate a negative temperature coefficient (NTC) thermistor to monitor a temperature of the stator windings of the motor. The NTC may be preferred for its relatively low component cost. However, the NTC is not serviceable and may have relatively low accuracy. Moreover, it may be desirable for the NTC to monitor a temperature of a welded hairpin associated with the stator. However, tolerances associated with the welded hairpin tend to be quite large, leading to difficulties ensuring accurate temperature measurements. Thus, there is a need in the art for an improved sensing system to prevent e-motor overheating and failures.

### SUMMARY

Apparatuses, temperature sensors, and methods for assembling an e-motor axial stator winding temperature sensor are disclosed. In a particular embodiment, the temperature sensor includes a housing configured to be fixed relative to an electric motor. The temperature sensor also includes a plunger disposed in the housing and a thermal sensor disposed in the plunger. In this embodiment, the plunger is movable relative to the housing to position the thermal sensor relative to the electric motor.

In another embodiment, a method of assembling a temperature sensor having a housing, a plunger, and a thermal sensor is disclosed. The method includes inserting the plunger axially into an opening defined by a necked portion of the housing. In this embodiment, the housing is configured for coupling to an electric motor and the plunger is movable relative to the housing to position the thermal sensor relative to the electric motor. The method also includes coupling one or more electrical connections within the temperature sensor, such that the thermal sensor is electrically coupled to a connector that is configured for connection with an external system.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

So that those having ordinary skill in the art to which the disclosed systems and techniques pertain will more readily understand how to make and use the same, reference may be had to the following drawings.

FIG. 1A is a diagram illustrating a perspective view of a temperature sensor for use with an e-motor, in accordance with embodiments of the present disclosure.

FIG. 1B is a diagram illustrating a different view of the temperature sensor of FIG. 1A.

FIG. 1C is a diagram illustrating a cross-sectional view of the temperature sensor of FIG. 1A.

FIG. 1D is a diagram illustrating an exploded cross-sectional view of the temperature sensor of FIG. 1A.

FIG. 2 is a flowchart to illustrate an implementation of a method for assembling a temperature sensor according to embodiments of the present disclosure.

### DETAILED DESCRIPTION

The terminology used herein for the purpose of describing particular examples is not intended to be limiting for further examples. Whenever a singular form such as “a”, “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises”, “comprising”, “includes” and/or “including”, when used, specify the presence of the stated features, integers, steps, operations, processes, acts, elements and/or components, but do not preclude the presence or addition of one or more other features, integers, steps, operations, processes, acts, elements, components and/or any group thereof.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e., only A, only B, as well as A and B. An alternative wording for the same combinations is “at least one of A and B”. The same applies for combinations of more than two elements.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

The subject technology overcomes prior art problems associated with conventional temperatures sensors used with electronic motors. For example, the systems and techniques described herein provide a temperature sensor that facilitates measuring temperatures of motor stators in e-motors. In some examples, an e-motor may have a stator with one or more welded hairpins. The temperature of the hairpin(s) may be a good indicator of proper functioning of the e-motor (e.g., higher temperatures may signify poor motor health).

To protect from overheating of stator windings of e-motors, current designs utilize a glued/welded NTC, which may be inexpensive component-wise, but has several limitations making it much more expensive on system level, namely non-serviceable and with low accuracy. The sensor systems described herein may provide improved and repeatable response time, high accuracy, a moveable plunger in the axial direction, and a tight environmental seal. According to embodiments of the present disclosure, a moveable spring-preloaded plunger of a temperature sensor improves proper response time measurement and compensation of stator winding relative displacement of the motor housing. In addition, thermal decoupling of the sensing element from the cooling medium also improves accuracy measurement. Furthermore, rubber environmental seals and plastic weld/adhesive may provide leak tightness.

The systems and techniques disclosed herein may also facilitate ready replacement and installation of a temperature sensor on an e-motor. The systems and techniques disclosed herein may also improve an operational range of a vehicle using the e-motor (e.g., by ensuring the motor is functioning properly), improve safety outcomes associated with the e-motor (e.g., by reliably sensing motor anomalies), and/or reduce assembly time.

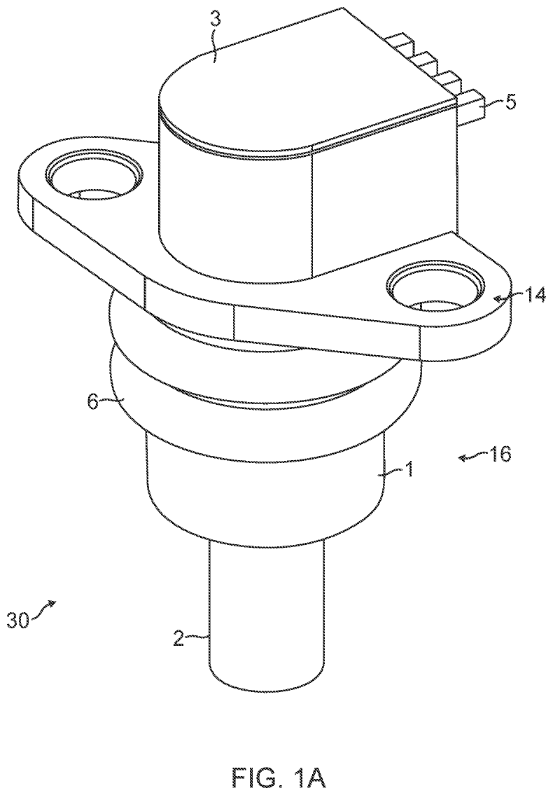

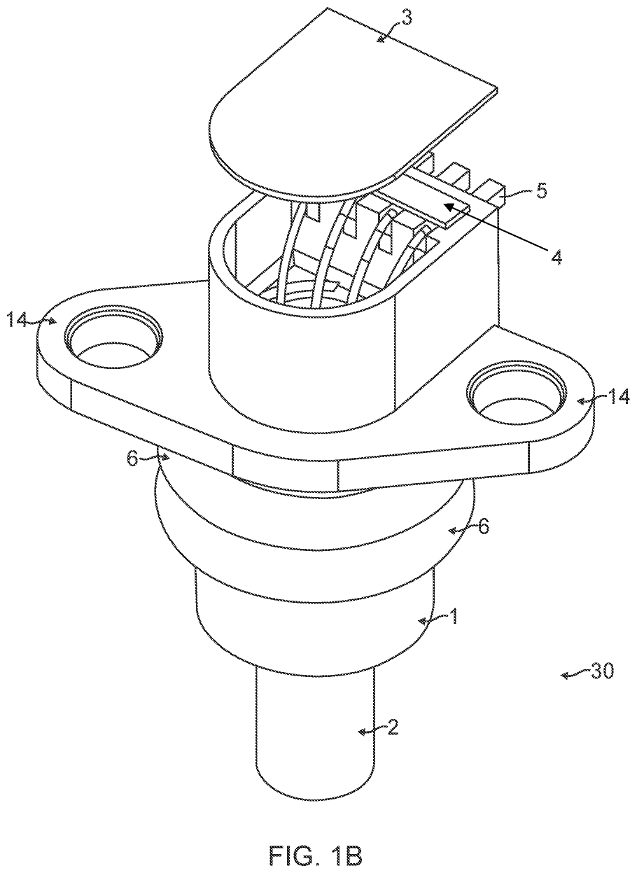

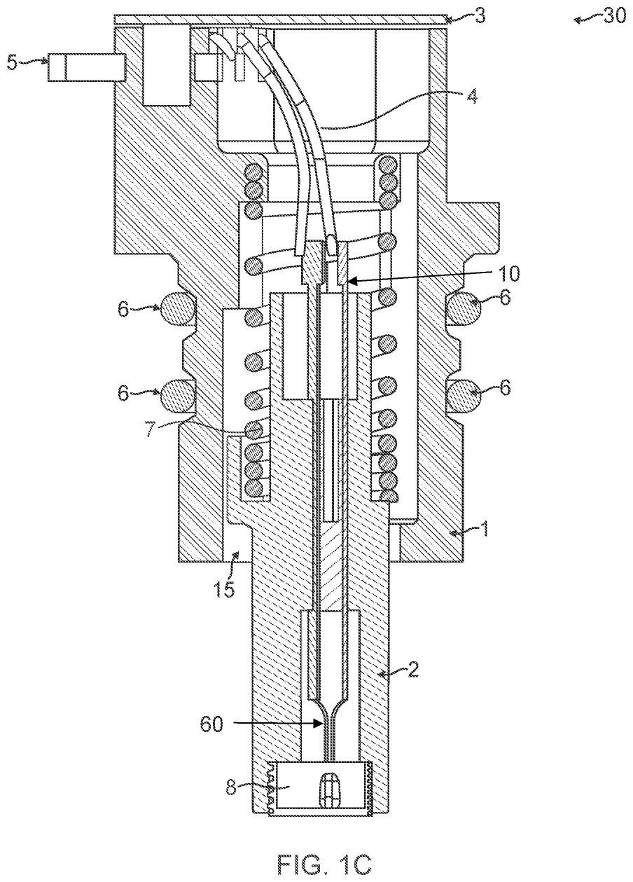

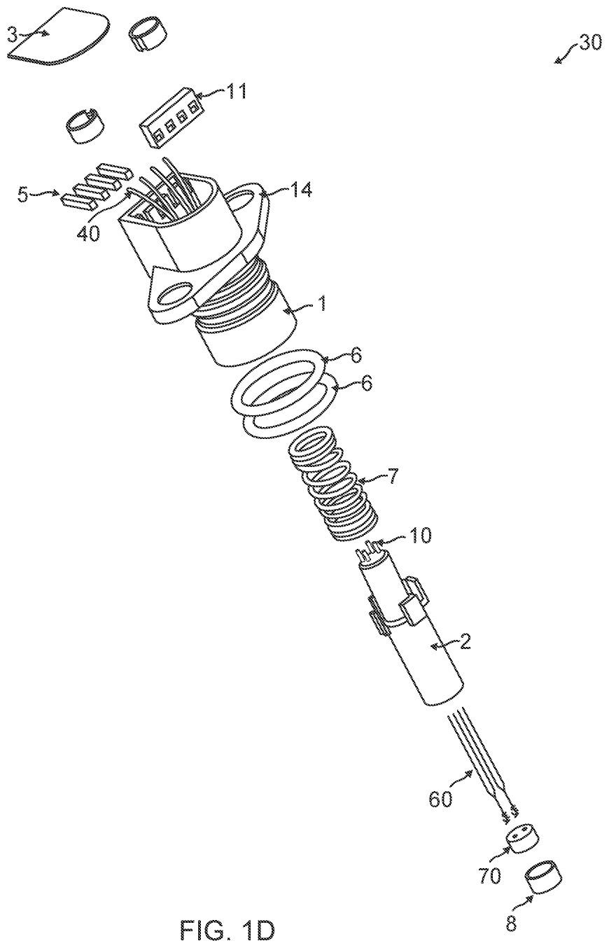

For further explanation, FIG. 1A sets forth a diagram illustrating a perspective view of a temperature sensor 30 for use with an e-motor, in accordance with embodiments of the present disclosure. FIG. 1B is a diagram illustrating a different view of the temperature sensor of FIG. 1A. FIG. 1C is a diagram illustrating a cross-sectional view of the temperature sensor of FIG. 1A. FIG. 1D is a diagram illustrating an exploded cross-sectional view of the temperature sensor of FIG. 1A.

As illustrated in FIGS. 1A-D, the temperature sensor 30 includes a housing 1, a plunger 2, a lid 3, a moveable electrical connection 4, a connector 5, an environmental seal 6, a spring 7, and a plunger cap 8 with a thermal sensor 70 having thermal interface material (TIM). In the examples of FIGS. 1A-D, the housing 1 is generally cylindrical, having a top surface, a bottom surface, and a generally cylindrical sidewall, extending between the top surface and the bottom surface. In the example temperature sensor 30, mounting tabs 14 extend outward from the sidewall of the housing. The mounting tabs 14 are illustrated as including through-holes formed therein. For instance, the through-holes can accommodate a shaft of a fastener, e.g., a bolt, or the like, to secure the temperature sensor 30 to a motor housing or other mounting structure. The housing 1 also includes a necked portion 16 extending from the bottom surface. The necked portion 16 of the housing 1 defines an opening 15 into an inner volume of the housing 1. The shape and arrangement of the housing 1 are for example only. In other examples, the housing 1 can be other than cylindrical, there may be other than two mounting tabs 14, the mounting tabs may be omitted, the necked portion 16 may be longer or shorter (or omitted), and/or the like.

In this example embodiment, the plunger 2 is at least partially disposed in the housing 1 and extends through the necked portion 16 to a terminal end spaced from the bottom surface of the housing 1. As detailed further herein, the plunger 2 may be movable relative to the housing 1 to effectuate contact of the thermal sensor 70 with a hairpin of an e-motor stator winding to sense the temperature of the hairpin, regardless of the location of the hairpin. The spring 7 provides a an axial force to maintain contact of the thermal sensor 70 with the monitored hairpin. Moving the position of the thermal sensor 70 provides for reliable temperature sensing despite relatively large tolerances associated with hairpin stator windings, as detailed further herein. In a particular embodiment, the plunger 2 and the spring 7 may slide axially inside the housing 1 and be secured through bayonet locking.

The connector 5 may facilitate connection, e.g., electrical connection, of the temperature sensor 30 to one or more external systems (not shown). For example, and without limitation, the connector 5 may have one or more pins and/or one or more receptacles (e.g., for receiving pins) to facilitate connection to an external system. The connector 5 is electrically coupled via a connection apparatus 11 to leads 40 disposed in a volume of the housing 1. More specifically, in FIG. 1D, a portion of the housing 1 is removed to expose the volume. In examples, the housing 1 can include the lid 3 or top that is removed in the example of FIG. 1D.

As best shown in FIG. 1D, the temperature sensor 30 includes the thermal sensor 70. One or more leads 60 are electrically connected to the thermal sensor 70. The one or more leads 60 are electrically coupled connectors 10, which are coupled to the leads 40 in the housing 1. The thermal sensor is disposed in an axial opening extending through the plunger 2. The thermal sensor 70 may be arranged proximate a bottom of the plunger 2. In some examples, the thermal sensor 70 may be secured in the plunger 2 via a clip. The clip may be a spring clip or other mounting device that is at least partially resilient, deformable, and/or deflectable. In examples, the clip may facilitate reliable and accurate contact of a stator winding hairpin or other feature to be monitored by the thermal sensor 70. In other embodiments, a clip is not used and the spring 7 provide sufficient axial force on the plunger 2 to effectuate contact between the thermal sensor 70 and the monitored hairpin.

For assembly, the spring 7 and the plunger 2 are inserted axially into the opening 15 defined by the necked portion 16, described above. Once inserted, the spring 7 is in contact with the terminal end spaced from the bottom surface of the housing 1 and provides an axial force against the plunger 2. Assembly also includes coupling one or more electrical connections (10, 4, 40, 60) within the temperature sensor 30, such that the thermal sensor 70 is electrically coupled to the connector 5 that is configured for connection with an external system.

The thermal sensor 70 may be positioned within the plunger cap 8 and over molded with the thermal interface material (TIM). In this example, the preloaded spring 7 secures the proper contact between the plunger cap 8 and an e-motor stator winding to enable fast response time and accuracy reading. Continuing with this example, the plunger cap 8 is inserted into the housing 1 for thermal decoupling from the stator cooling medium. A signal is transferred through the moveable electrical connection 4 and the sensor leak tightness is guaranteed through the environmental seals 6. This design also allows for high accuracy by air gap decoupling of the thermal sensor's environment and via thermal decoupling of the thermal sensor and the e-motor cooling oil. In a particular embodiment, the temperature sensor 30 may also include a redundant sense element. For example, the redundant sense element may be a negative temperature coefficient (NTC) thermistor and a positive temperature coefficient (PTC) or two NTC thermistor.

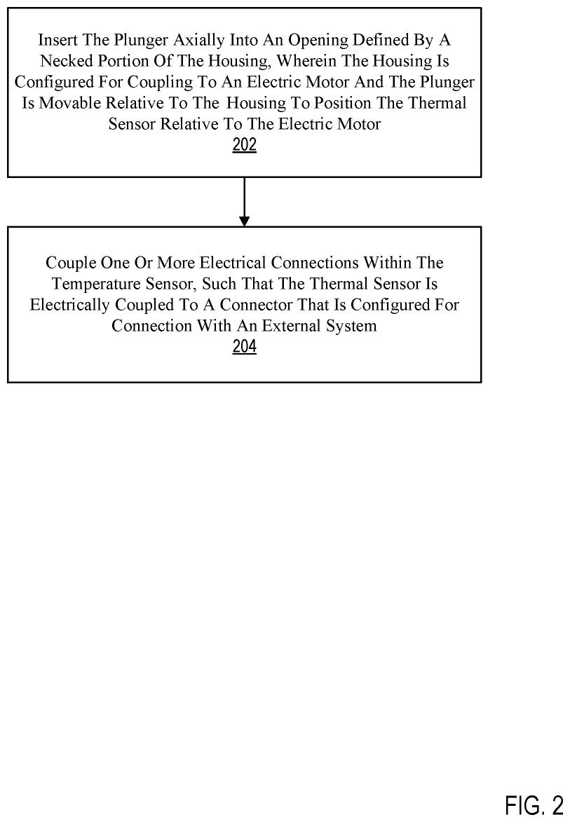

For further explanation, FIG. 2 is a flowchart to illustrate an implementation of a method for assembling a temperature sensor apparatus according to embodiments of the present disclosure. The method of FIG. 2 includes inserting 202 a plunger axially into an opening defined by a necked portion of the housing. For example, the plunger 2 in FIGS. 1A-D may be inserted into opening 15 of the housing 1. In the example of FIG. 2, the housing is configured for coupling to an electric motor and the plunger is movable relative to the housing to position the thermal sensor relative to the electric motor.

The method of FIG. 2 also includes coupling 204 one or more electrical connections within the temperature sensor, such that the thermal sensor is electrically coupled to a connector that is configured for connection with an external system. In the example temperature sensor 30 of FIGS. 1A-D, the thermal sensor 70 is coupled to the connector 5 via the electrical connections (electrical connectors 10, electrical connection 4, the leads 60, the leads 40).

As will be appreciated from the foregoing, aspects of the current disclosure provide a temperature sensing mechanism that allows for accurate temperature sensing in e-motors, even with relatively large tolerances associated with to-be-measured features, such as hairpins. In examples, this disclosure enables consistent and reliable temperature readings between the sensing element and the stator winding hairpin, which simplifies the motor control scheme, as well as enables significant reduction of system level cost (serviceability, ease of assembly, and reliability of e-motors).

All orientations and arrangements of the components shown herein are used by way of example only. Further, it will be appreciated by those of ordinary skill in the pertinent art that the functions of several elements may, in alternative embodiments, be carried out by fewer elements or a single element. Similarly, in some embodiments, any functional element may perform fewer, or different, operations than those described with respect to the illustrated embodiment. Also, functional elements shown as distinct for purposes of illustration may be incorporated within other functional elements in a particular implementation.

While the subject technology has been described with respect to embodiments, those skilled in the art will readily appreciate that various changes and/or modifications can be made to the subject technology without departing from the spirit or scope of the subject technology. For example, each claim may depend from any or all claims in a multiple dependent manner even though such has not been originally claimed.

Advantages and features of the present disclosure can be further described by the following statements:
1. A temperature sensor comprising a housing configured to be fixed relative to an electric motor; a plunger disposed in the housing; and a thermal sensor disposed in the plunger, wherein the plunger is movable relative to the housing to position the thermal sensor relative to the electric motor.
2. The temperature sensor of statement 1 further comprising a spring coupled to the plunger to provide an axial force on the plunger that moves the plunger translationally to effectuate contact of the thermal sensor with a stator winding hairpin of the electric motor.
3. The temperature sensor of statement 1 or 2 further comprising a static sensor environmental seal coupled the housing.
4. The temperature sensor of any of statements 1-3, wherein the static sensor environmental seal includes at least one of one or more rubber seals and plastic weld/adhesive.
5. The temperature sensor of any of statements 1-4, wherein the thermal sensor is positioned within a plunger cap.
6. The temperature sensor of any of statements 1-5, wherein the plunger cap is inserted into the housing for thermal decoupling from a stator medium of the electric motor.
7. The temperature sensor of any of statements 1-6, wherein the thermal sensor is overmolded with a thermal interface material.
8. The temperature sensor of any of statements 1-7 further comprising a redundant sense element.
9. The temperature sensor of any of statements 1-8, wherein the redundant sense element includes a negative temperature coefficient (NTC) thermistor and a positive temperature coefficient (PTC) or two NTC thermistor.
10. The temperature sensor of any of statements 1-9, wherein the redundant sense element includes two negative temperature coefficient (NTC) thermistors.
11. The temperature sensor of any of statements 1-10 further comprising a connector configured for coupling to an external system, the connector coupled to the thermal sensor via electrical connections.
12. A method of assembling a temperature sensor, the temperature sensor having a housing, a plunger, and a thermal sensor, the method comprising inserting the plunger axially into an opening defined by a necked portion of the housing, wherein the housing is configured for coupling an electric motor and the plunger is movable relative to the housing to position the thermal sensor relative to the electric motor; and coupling one or more electrical connections within the temperature sensor, such that the thermal sensor is electrically coupled to a connector that is configured for connection with an external system.
13. The method of statement 12 wherein the temperature sensor further includes a spring coupled to the plunger to provide an axial force on the plunger that moves the plunger translationally to effectuate contact of the thermal sensor with a stator winding hairpin of the electric motor.
14. The method of statement 12 or 13 wherein the temperature sensor further includes a static sensor environmental seal coupled the housing.
15. The method of any of statements 12-14, wherein the static sensor environmental seal includes at least one of one or more rubber seals and plastic weld/adhesive.
16. The method of any of statements 12-15, wherein the thermal sensor is positioned within a plunger cap.
17. The method of any of statements 12-16, wherein the plunger cap is inserted into the housing for thermal decoupling from a stator medium of the electric motor.
18. The method of any of statements 12-17, wherein the thermal sensor is overmolded with a thermal interface material.
19. The method of any of statements 12-18, wherein the temperature sensor further includes a redundant sense element.
20. The method of any of statements 12-19, wherein the temperature sensor further includes a connector configured for coupling to an external system, the connector coupled to the thermal sensor via electrical connections.

One or more embodiments may be described herein with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A temperature sensor comprising:
a housing configured to be fixed relative to an electric motor;
a plunger disposed in the housing; and
a thermal sensor disposed in the plunger, wherein the plunger is movable relative to the housing to position the thermal sensor relative to the electric motor.

2. The temperature sensor of claim 1 further comprising a spring coupled to the plunger to provide an axial force on the plunger that moves the plunger translationally to effectuate contact of the thermal sensor with a stator winding hairpin of the electric motor.

3. The temperature sensor of claim 1 further comprising a static sensor environmental seal coupled the housing.

4. The temperature sensor of claim 3 wherein the static sensor environmental seal includes at least one of one or more rubber seals and plastic weld/adhesive.

5. The temperature sensor of claim 1 wherein the thermal sensor is positioned within a plunger cap.

6. The temperature sensor of claim 5 wherein the plunger cap is inserted into the housing for thermal decoupling from a stator medium of the electric motor.

7. The temperature sensor of claim 1 wherein the thermal sensor is overmolded with a thermal interface material.

8. The temperature sensor of claim 1 further comprising a redundant sense element.

9. The temperature sensor of claim 8, wherein the redundant sense element includes a negative temperature coefficient (NTC) thermistor and a positive temperature coefficient (PTC) or two NTC thermistor.

10. The temperature sensor of claim 8, wherein the redundant sense element includes two negative temperature coefficient (NTC) thermistors.

11. The temperature sensor of claim 1 further comprising a connector configured for coupling to an external system, the connector coupled to the thermal sensor via electrical connections.

12. A method of assembling a temperature sensor, the temperature sensor having a housing, a plunger, and a thermal sensor, the method comprising:
inserting the plunger axially into an opening defined by a necked portion of the housing, wherein the housing is configured for coupling to an electric motor and the plunger is movable relative to the housing to position the thermal sensor relative to the electric motor; and
coupling one or more electrical connections within the temperature sensor, such that the thermal sensor is electrically coupled to a connector that is configured for connection with an external system.

13. The method of claim 12 wherein the temperature sensor further includes a spring coupled to the plunger to provide an axial force on the plunger that moves the plunger translationally to effectuate contact of the thermal sensor with a stator winding hairpin of the electric motor.

14. The method of claim 12 wherein the temperature sensor further includes a static sensor environmental seal coupled the housing.

15. The method of claim 14 wherein the static sensor environmental seal includes at least one of one or more rubber seals and plastic weld/adhesive.

16. The method of claim 12 wherein the thermal sensor is positioned within a plunger cap.

17. The method of claim 16 wherein the plunger cap is inserted into the housing for thermal decoupling from a stator medium of the electric motor.

18. The method of claim 12 wherein the thermal sensor is overmolded with a thermal interface material.

19. The method of claim 12 wherein the temperature sensor further includes a redundant sense element.

20. The method of claim 12 wherein the temperature sensor further includes a connector configured for coupling to an external system, the connector coupled to the thermal sensor via electrical connections.
